(19) United States
(12) Patent Application Publication
(10) Pub. No.: US 2026/0216975 A1
(43) Pub. Date: Jul. 30, 2026

(54) COMPOSITE HYBRID PART

(71) Applicant: SABIC GLOBAL TECHNOLOGIES B.V., Bergen op Zoom (NL)

(72) Inventors: Ilona Maria Francois GROND-SOONS, Schimmert (NL); Davy Wilhelmus Anna BRANDS, Maastricht (NL); David PELLETIER, Bergen op Zoom (NL)

(21) Appl. No.: 19/141,666

(22) PCT Filed: Dec. 18, 2023
(86) PCT No.: PCT/EP2023/086322

§ 371 Date: Jun. 20, 2025

(30) Foreign Application Priority Data
Dec. 19, 2022 (EP) 22214438.8

(51) Int. Cl. B29C 70/68; B29C 45/14; B29C 70/00; B29K 23/00; B29K 105/00; B29L 31/30

(52) U.S. Cl. CPC B29C 70/68; B29C 45/14631; B29C 70/003; B29K 2023/12; B29K 2105/0032; B29K 2105/0044; B29L 2031/3005

(57) ABSTRACT

A method of forming a composite hybrid part including moulding a composite including a polymer matrix and an insert in the polymer matrix; and forming an aesthetic polymer outer film on a surface of the composite in a same step as the moulding of the composite, wherein a thickness of the aesthetic polymer outer film is less than 1 millimeter (mm), 0.01 to 0.7 mm, 0.05 to 0.5 mm, or 0.05 to less than 0.5 mm.

### BACKGROUND

Parts, for example, vehicle parts (e.g., parts for a motorized vehicle such as a car), with good aesthetics can avoid additional claddings, which can increase weight and cost, two Critical to Quality (CTQ) characteristics. An interest exists for parts with good aesthetics.

These and other inefficiencies and opportunities for improvement are addressed by the processes, methods, and products, e.g., parts, of the present disclosure.

### BRIEF DESCRIPTION

The present disclosure provides improved processes, methods, and products, e.g., parts, including a composite and a polymer outer layer. More particularly, the present disclosure provides, in various aspects, advantageous methods for forming a composite hybrid part.

The present disclosure provides a method of forming a composite hybrid part including moulding a composite including a polymer matrix and an insert in the polymer matrix; and forming an aesthetic polymer outer film on a surface of the composite in a same step as the moulding of the composite, wherein a thickness of the aesthetic polymer outer film is less than 1 millimeter (mm), 0.01 to 0.7 mm, 0.05 to 0.5 mm, or 0.05 to less than 0.5 mm.

The above described and other features are exemplified by the following detailed description.

Any combination or permutation of aspects is envisioned. Additional advantageous features, functions and applications of processes, methods, and products, e.g., parts, of the present disclosure will be apparent from the description which follows.

### DETAILED DESCRIPTION

Aspects disclosed herein are illustrative of advantageous methods of forming a composite hybrid part. It should be understood, however, that disclosed aspects are merely exemplary of the present disclosure, which may be embodied in various forms. Therefore, details disclosed herein with reference to exemplary methods are not to be interpreted as limiting.

The present disclosure provides advantageous methods of forming a composite hybrid part. The present disclosure provides that it was surprisingly discovered that a composite hybrid part could be formed in a one step process. A one step process can provide cost benefits, for example, by eliminating separate forming tools.

The disclosed method of forming a composite hybrid part includes moulding a composite including a polymer matrix and an insert material (also referred to herein as an insert), for example, continuous reinforcing fibers, in the polymer matrix; and forming an aesthetic polymer outer film on a surface of the composite in a same step as the moulding of the composite, wherein a thickness of the aesthetic polymer outer film is less than 1 mm, 0.01 to 0.7 mm, 0.05 to 0.5 mm, or 0.05 to less than 0.5 mm. The aesthetic polymer outer film can be formed on one surface of the composite or multiple, e.g., opposite, surfaces of the composite.

The thin thickness of the aesthetic polymer outer film can allow for the formation of a composite hybrid part in a one step process. The thin thickness of the aesthetic polymer outer film can also allow for a thicker composite to be used than if a thicker polymer outer film were to be used. In an aspect, the composite includes a tape having a matrix material with continuous reinforcing fibers embedded in the matrix material, and the thin thickness of the aesthetic polymer outer film can allow for multiple layers of tape to be included in the composite.

In an aspect, the composite hybrid part can be made by laying up the composite in an injection moulding tool. The layup can be automated or manual. The injection moulding tool can be preheated so that a glass transition temperature of the polymer matrix of the composite is reached. Then the heated layup can be compressed for consolidation followed by solidification of the compressed layup. Then formation of the aesthetic polymer outer film is accomplished by injection of polymer into the injection moulding tool. The moulding of the composite and the forming of the aesthetic polymer outer film on the surface of the composite can be performed in a cavity of an injection moulding tool.

An outer surface of the aesthetic polymer outer film can include a pattern. The pattern can be an irregular pattern or a regular pattern. The pattern can be formed on an outer surface of the aesthetic polymer outer film in a same step as the forming of the aesthetic polymer outer film. The forming of the pattern can include imprinting the pattern in the outer surface of the aesthetic polymer outer film. For example, the aesthetic polymer outer film layer can be pressed against the mould, allowing for graining to be imprinted in the aesthetic polymer outer film by a pressing of the mould into the aesthetic polymer outer film to imprint the grain.

The composite has a relatively tight fit in the mould, not only allowing for an aesthetic polymer outer film having a thin thickness of less than 1 mm, 0.01 to 0.7 mm, 0.05 to 0.5 mm, or 0.05 to less than 0.5 mm, to be formed on the composite, but also helping to prevent the composite from moving in the mould. The tight fit can aid in the one step process of forming the composite hybrid part. In contrast, if additional cavity volume were present between the composite and the mould, the composite could move within the mould, and the polymer layer may not be properly formed on the composite. Additional cavity volume can create a risk for correct positioning of the composite, which can have room to move within the mould.

The term “aesthetic polymer outer film” is used herein merely for convenience, and can refer to a single-layered aesthetic polymer outer film a multi-layered aesthetic polymer outer film includes several layers. In an aspect, the aesthetic polymer outer film can include several layers, e.g., the aesthetic polymer outer film can include a surface layer and an additional layer. The materials included in the aesthetic polymer outer film can be employed in the surface layer, the additional layer, or a combination thereof. If the aesthetic polymer outer film includes an additional layer, the additional layer can be compatible with any other layer making up the aesthetic polymer outer film, the composite, and any other layers adjacent to the additional layer.

The composite and the aesthetic polymer outer film can include the same or different plastic materials that are compatible with each other. As used herein, “compatible” means that the layers are capable of being joined, and do not adversely interact with each other. The plastic materials can include thermoplastic materials, thermoset materials, or a combination thereof. Exemplary thermoplastic materials include polypropylene, polycarbonate (PC), polyester, polyetherimide (PEI), polyarylene ethers, or a combination thereof, for example, a PC/poly(ethylene terephthalate) (PET) blend. Suitable thermoplastic polyesters include, for example, a poly(alkylene dicarboxylate) such as PET, poly(1,4-butylene terephthalate) (PBT), poly(trimethylene terephthalate) (PTT), poly(ethylene naphthalate) (PEN), poly(butylene naphthalate) (PBN), poly(cyclohexanedimethanol terephthalate), poly(cyclohexanedimethanol-co-ethylene terephthalate) (PETA), or poly(1,4-cyclohexanedimethyl-1,4-cyclohexanedicarboxylate) (PCCD); a poly(alkylene arenedioate); or a combination thereof.

In an aspect, the composite and aesthetic polymer outer film each include a polycarbonate. Linear or branched aromatic polycarbonates can be used. In an aspect, polycarbonates including units derived from 2,2-bis(4-hydroxyphenyl) propane (“Bisphenol A”), bis(2-hydroxyphenyl) methane, 1,1-bis(4-hydroxyphenyl)-3,3,5-trimethylcyclohexane, fluorenone bisphenol, 1,1-bis(4-hydroxyphenyl) ethane, 2,6-dihydroxynaphthalene, bis(3,5-diethyl-4-hydroxyphenyl) sulfone, 2,2-bis(3,5-dibromo-4-hydroxyphenyl) propane, 4,4′-dihydroxydiphenyl ether, spiro biindane bisphenol, or a combination thereof can be used.

Exemplary thermoset materials include thermosetting resins such as epoxy, phenolic, alkyds, polyester, polyimide, polyurethane, mineral filled silicone, bis-maleimides, cyanate esters, vinyl, and benzocyclobutene resins, in addition to blends, copolymers, mixtures, reaction products, and composites thereof.

In an aspect, the aesthetic polymer outer film can include polyacetal, polyacrylic, styrene acrylonitrile, acrylonitrile-butadiene-styrene, polycarbonate, polystyrene, polyethylene, polyphenylene ether, polypropylene, polyethylene terephthalate, polybutylene terephthalate, nylon, polyamideimide, polyarylate, polyurethane, ethylene propylene diene rubber, ethylene propylene diene monomer, polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone, liquid crystal polymer, or a combination thereof. In an aspect each of the polymer matrix and the aesthetic polymer outer film includes polypropylene.

The composite, aesthetic polymer outer film, or a combination thereof can include an additive for the provision or enhancement of a visual effect. Such visual additives include, but are not limited to, pigments and decorative material such as metal flakes, dyes, and luminescent compounds. Specific examples of suitable additives include metallic oxides (such as titanium dioxide and iron oxide); metal hydroxides; metal flakes (such as aluminum flake); chromates (such as lead chromate); sulfides; sulfates; carbonates; carbon black; silica; talc; china clay; phthalocyanine blues and greens, organo reds; organo maroons and other organic pigments and dyes, or a combination thereof. In an aspect, pigments that are stable at high temperatures are used, i.e., colorants that do not substantially degrade or alter at temperatures at or above 350° C.

Light fastness additives can also be present in the composite, aesthetic polymer outer film, or combination thereof. For example, the composite, aesthetic polymer outer film, or combination thereof can further include a light fastness compound, a light fastness antioxidant, a light fastness ozonant, or a combination thereof. Examples of light fastness compounds include didodecyl-3,3′-thio dipropionate, tris(4-tert-butyl-3-hydroxy-2,6-dimethyl benzyl)isocyanurate, 1,3,5-trimethyl-2,4,6-tris(3,5-di-tert-butyl-4-hydroxybenzyl)benzene, N, N′-beta, beta′-naphthalene-4-phenylene diamine, 4,4′-methylene-bis(dibutyl dithio-carbamate), or 2,2,4-trimethyl-1,2-hydroquinoline.

In addition or alternative to the disclosed additives, property additives can be included in the composite, aesthetic polymer outer film, or combination thereof. Exemplary property additives include an impact modifier, an ultraviolet (UV) absorber, a flame retardant, a filler, a stabilizer, an ester interchange inhibitor, an adhesion promoting agent such as a bisphenol derivative, an aminosilane or a derivative thereof, a mould release agent, or a combination thereof. Examples of ultraviolet light absorbers (UVA) include benzotriazole, benzophenone, triazine, cyanoacrylate, dibenzoylresorcinol, benzoxazinone, and hindered amine light stabilizers (HALS) such as 2-(benzotriazol-2-y1)-4-(1,1,3,3-tetramethylbutyl)phenol, 2-(benzotriazole-2-yl)-4-methylphenol, 2-hydroxy-4-octyloxy benzophenone, 2-hydroxy-4-methoxybenzophenone, ethyl-2,2-diphenyl-1-cyanoacrylate, 2-(2′-hydroxy-4′-octyloxy)bis-4,6-(2′,4′-dimethylphenyl)triazine, 2-ethyl-2′-ethoxy oxalanide, or bis[2-hydroxy-5-methyl-3-(benzotriazol-2-yl)phenyl]-methane. Combinations of additives can also be used.

In an aspect, the aesthetic polymer outer film does not include an insert material, for example, reinforcing fibers. In an aspect, the aesthetic polymer outer film includes an insert material, for example, reinforcing fibers.

The insert can include a metallic insert, for example, a metallic layer, or a composite laminate insert. In an aspect, the metallic insert can include, for example, coated or uncoated stainless or non-stainless steel, coated or uncoated aluminum, coated or uncoated magnesium, coated or uncoated titanium, coated or uncoated chrome, coated or uncoated zinc or a combination thereof.

The insert can include a fiber material, for example, processed mineral fibers such as those derived from blends including aluminum silicates, aluminum oxides, magnesium oxides, or calcium sulfate hemihydrate; natural fibers including wood flour, cellulose, cotton, sisal, jute, starch, cork flour, lignin, ground nut shells, corn, or rice grain husks; synthetic reinforcing fibers, including polyester fibers such as polyethylene terephthalate fibers, polyvinyl alcohol fibers, aromatic polyamide fibers, polybenzimidazole fibers, polyimide fibers, polyphenylene sulfide fibers, polyether ether ketone fibers, boron fibers, ceramic fibers such as silicon carbide, or fibers from mixed oxides of aluminum, boron, or silicon; single crystal fibers or “whiskers” including silicon carbide fibers, alumina fibers, boron carbide fibers, iron fibers, nickel fibers, or copper fibers; glass fibers, including textile glass fibers such as E, A, C, ECR, R, S, D, or NE glasses, or quartz; or treated or un-treated carbon fibers such as vapor-grown carbon fibers including those having an average diameter of about 3.5 to about 500 nanometers.

Non-limiting examples of fiber material include short inorganic fibers, including processed mineral fibers such as those derived from blends including aluminum silicates, aluminum oxides, magnesium oxides, or calcium sulfate hemihydrate, boron fibers, ceramic fibers such as silicon carbide, or fibers from mixed oxides of aluminum, boron or silicon. Also included are single crystal fibers or “whiskers” including silicon carbide, alumina, boron carbide, iron, nickel, or copper. Fiber materials such as glass fibers, basalt fibers, including textile glass fibers or quartz can also be included.

Also included are natural organic fibers including wood flour obtained by pulverizing wood, or fibrous products such as cellulose, cotton, sisal, jute, cloth, hemp cloth, felt, or natural cellulosic fabrics such as Kraft paper, cotton paper or glass fiber containing paper, starch, cork flour, lignin, ground nut shells, corn, rice grain husks, or a combination thereof.

Organic reinforcing fiber materials or synthetic reinforcing fibers can be used, for example, organic polymers capable of forming fibers such as polyethylene terephthalate, polybutylene terephthalate or other polyesters, polyarylates, polyethylene, polyvinyl alcohol, polytetrafluoroethylene, acrylic resins, high tenacity fibers with high thermal stability including aromatic polyamides, polyaramid fibers such as Kevlar (product of Du Pont), polybenzimidazole, polyimide fibers such as polyimide 2080 or PBZ fiber (both products of Dow Chemical Company); or polyphenylene sulfide, polyether ether ketone, polyimide, polybenzoxazole, aromatic polyimides or polyetherimides, or a combination thereof.

In an aspect, the composite can include a, e.g., at least one, layer of a tape having a matrix material with continuous reinforcing fibers embedded in the matrix material. The matrix material can be a thermoplastic material, such as a poly olefin. The continuous reinforcing fibers can be directed in a longitudinal direction of the tape. The term “continuous fiber” can refer to fibers having the same length as the tape, e.g., the fiber stretches the length of the tape.

The composite can be made of two or more layers of the tape. The continuous fibers in each layer can be oriented in a different direction with respect to a longitudinal direction of the tape. The orientation of the fibers in one layer with respect to the fibers in another layer can range from −90° to +90°. An angle between the longitudinal direction of the continuous fibers of a first layer and the longitudinal direction of the continuous fibers of a second layer can range from −45° to +45°. The thickness of the composite can range from 0.1 to 6.0 mm. The thickness of one layer can vary from 0.1 to 0.3 mm. A multiple layer composite can be used, having a thickness of 1.5 to 4.5 mm, or 2.0 to 4.0 mm. The thickness of the composite can vary over a width direction thereof, longitudinal direction thereof, or a combination thereof, to locally increase reinforcement.

In an aspect, the composite includes a first layer including a first polymer matrix with a first insert, for example, first continuous reinforcing fibers, embedded in the first polymer matrix; and a second layer including a second polymer matrix with a second insert, for example, second continuous reinforcing fibers, embedded in the second polymer matrix.

The composite can include, or consist of, a combination of a polypropylene (PP) reinforced with long fibers. In an aspect, the composite can include PP and 30 to 60 weight percent (wt. %), for example, 40 wt. %, of long glass fibers, e.g., STAMAX™ manufactured by SABIC, based on a total weight of the composite. As used herein, the phrase “long glass fibers” refers to glass fibers having a length of at least 10 mm, for example, 10 to 55 mm, 10 to 40 mm, 10 to 30 mm, or 10 to 20 mm. In an aspect, the composite can include short glass fibers having a length of less than 10 mm, or less than 1 mm, or less than 0.5 mm, for example, 0.1 to 2 mm, 0.1 to 1 mm, 0.1 to 0.5 mm, 2 to 7 mm, or 3 to 5 mm. The length of the glass fibers is determined before melt-mixing with polyolefin.

The composite can include a polypropylene reinforced with continuous fibers, e.g., continuous glass fibers. In an aspect, the composite can include two or more layers of unidirectional tape, which are stacked on top of each other under certain stacking angles or ply angles. Each of the layers of tape can include 30 to 60 volume percent (vol. %), for example, 45 vol. %, continuous glass fibers, based on a total volume of the layer of tape.

The composite can include a tape of unidirectional continuous fibers in a matrix material. Woven fibers, e.g., a textile from reinforcing fibers, can be used. Continuous length fiber composites, i.e., wherein the length of the fibers coincides with the length of the tape, can offer superior stiffness and strength versus woven fibers composites and long, non-continuous, fiber filled materials.

Fiber type, size, or amount can vary with the matrix material employed in making the composite. Exemplary fiber types include, but are limited to, a glass fiber (e.g., E-glass (“electrical glass”, e.g., borosilicate glass) or S-glass (“structural glass”, e.g., magnesia/alumina/silicate glass)), a mineral fiber, a polymer fiber, a natural fiber, or a combination thereof. The fiber diameter (width) can be 6 micrometers to 25 micrometers. The fiber length can be 2 to 75 mm. In an aspect, the continuous reinforcing fibers include glass fiber, carbon fiber, aramid fiber, thermoplastic fiber, basalt fiber, or a combination thereof.

The composite can include 25 to 75 wt. %, 35 to 65 wt. %, or 40 to 60 wt. % matrix material. The composite can include 25 to 75 wt. %, 35 to 65 wt. %, or 40 to 60 wt. % fibers. The weight percentages are based on the total weight of the composite.

In an aspect, the aesthetic polymer outer film is directly on the surface of the composite. In an aspect, optionally disposed between the composite and aesthetic polymer outer film can be a tie-layer.

Use of a tie-layer can provide enhanced bonding, by increasing the amount of resin at the interface, and or by improving the compatibility between the aesthetic polymer outer film and the composite, for example, when the composite and aesthetic polymer outer film include different resins. The tie-layer can include a material that is selected to be compatible with the aesthetic polymer outer film and the composite. Specific examples of a compatible material for use in the tie-layer include a polycarbonate; a polyester such as PET, PBT, PTT, PEN, PBN, PETA and PCCD; a polyetherimide; a polyamide; a polyalkylene arenedioate; a polyacrylonitrile-containing resin such as, for example, acrylonitrile butadiene styrene (ABS), acrylonitrile butadiene acrylate (ASA), or acrylonitrile-(ethylene-polypropylene diamine modified)-styrene (AES); phenylene sulfide; polymethyl methacrylate (PMMA); copolyester carbonates; poly(alkylene dicarboxylates); or a combination thereof. In an aspect, the tie-layer includes a blend of a resin from the aesthetic polymer outer film and a resin from the composite.

Polycarbonates and blends of polycarbonates with polyesters can be used in the tie-layers, for example, in combination with aesthetic polymer outer films including arylate polyester resins. Suitable polycarbonate resins include linear aromatic polycarbonate resins, for example, those including units derived from bisphenol A, and branched aromatic polycarbonate resins.

Polyesters and blends including two or more of polyesters can also be used in the tie-layer, for example, in combination with aesthetic polymer outer films including arylate polyester resins. For example, one suitable blend for use in the tie-layer includes, based on the weight of the blend, 10 to 50 wt. % of PBT, PET, glycolized poly(ethylene terephthalate), or poly(cyanoterephthalydene) (PCT) and 50 to 90 wt. % of an arylate polyester resin, for example, a resorcinol polyester resin, and 50 to 90 wt. % of a resin including resorcinol arylate units.

A composite hybrid part formed by the disclosed method may include a vehicle body panel. The term “vehicle” as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 to 20 wt. %”, is inclusive of the endpoints and all intermediate values of the ranges of “5 to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “aspects”, “embodiments”, “examples”, and so forth, means that a particular element described in connection with the example is included in at least one example described herein, and may or may not be present in other examples. In addition, it is to be understood that the described elements may be combined in any suitable manner in the various aspects. The phrase “a combination thereof” or “a combination comprising at least one of the foregoing” is open-ended and includes one or more of the listed items, and can include other like items that are not listed.

Unless specified to the contrary herein, all test standards are the most recent standard in effect as of the filing date of this application, or, if priority is claimed, the filing date of the earliest priority application in which the test standard appears. Unless defined otherwise, technical and scientific terms used herein have the same meaning as is commonly understood by one of skill in the art to which this application belongs.

Compounds are described using standard nomenclature. Unless otherwise defined herein, the term “hydrocarbon” means a compound that includes carbon and hydrogen, optionally with 1 to 3 heteroatoms.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of forming a composite hybrid part comprising:
moulding a composite comprising a polymer matrix and an insert in the polymer matrix; and
forming an aesthetic polymer outer film on a surface of the composite in a same step as the moulding of the composite,
wherein a thickness of the aesthetic polymer outer film is less than 1 millimeter, 0.01 to 0.7 millimeters, 0.05 to 0.5 millimeters, or 0.05 to less than 0.5 millimeters.

2. The method of claim 1, wherein the insert comprises continuous reinforcing fibers.

3. The method of claim 2, wherein an outer surface of the aesthetic polymer outer film comprises a pattern.

4. The method of claim 3, wherein the pattern comprises an irregular pattern.

5. The method of claim 3, wherein the pattern comprises a regular pattern.

6. The method of claim 1, further comprising forming a pattern on an outer surface of the aesthetic polymer outer film in a same step as the forming of the aesthetic polymer outer film, wherein the forming of the pattern comprises imprinting the pattern in the outer surface of the aesthetic polymer outer film.

7. The method of claim 6, wherein the composite comprises:
a first layer comprising a first polymer matrix with a first insert embedded in the first polymer matrix; and
a second layer comprising a second polymer matrix with a second insert embedded in the second polymer matrix.

8. The method of claim 7, wherein the aesthetic polymer outer film comprises polyacetal, polyacrylic, styrene acrylonitrile, acrylonitrile-butadiene-styrene, polycarbonate, polystyrene, polyethylene, polyphenylene ether, polypropylene, polyethylene terephthalate, polybutylene terephthalate, nylon, polyamideimide, polyarylate, polyurethane, ethylene propylene diene rubber, ethylene propylene diene monomer, polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone, liquid crystal polymer, or a combination thereof.

9. The method claim 8, wherein each of the polymer matrix and the aesthetic polymer outer film comprises polypropylene.

10. The method of claim 9, wherein the aesthetic polymer outer film does not comprise an insert material.

11. The method of claim 9, wherein the aesthetic polymer outer film comprises an insert material.

12. The method of claim 11, wherein the aesthetic polymer outer film is disposed directly on the surface of the composite.

13. The method of claim 11, further comprising a tie-layer between the aesthetic polymer outer film and the composite.

14. The method of claim 13, wherein the moulding of the composite and the forming of the aesthetic polymer outer film on the surface of the composite are performed in a cavity of an injection moulding tool.

15. A composite hybrid part formed by the method of claim 1.

16. The part of claim 15, wherein:
the insert comprises continuous reinforcing fibers; or
the part comprises a tie-layer between the aesthetic polymer outer film and the composite.

17. The part of claim 16, wherein an outer surface of the aesthetic polymer outer film comprises a pattern, wherein the pattern comprises an irregular pattern or a regular pattern.

18. The part of claim 17, wherein the composite comprises:
a first layer comprising a first polymer matrix with a first insert embedded in the first polymer matrix; and
a second layer comprising a second polymer matrix with a second insert embedded in the second polymer matrix.

19. The part of claim 18, wherein the aesthetic polymer outer film is one or more of:
formed of polypropylene; or
does not comprise an insert material; or
comprises an insert material; or
disposed directly on the surface of the composite; or
comprises a light fastness additive, including one or more of a light fastness compound, a light fastness antioxidant, a light fastness ozonant, or a combination thereof; or
comprises a visual additive, including one or more of metal flakes, dyes, and luminescent compounds.

20. A body panel of a motor vehicle, wherein the body panel comprises the part of claim 19.
